(19) United States
(12) Patent Application Publication
(10) Pub. No.: US 2006/0089291 A1
(43) Pub. Date: Apr. 27, 2006

(54) Cleaning composition

(75) Inventors: Christopher John Hall, N. Himberside (GB); Najem Yaqub, Lancashire (GB)

Correspondence Address: SALTER & MICHAELSON;THE HERITAGE BUILDING, 321 SOUTH MAIN STREET, PROVIDENCE, RI, 029037128, US

(73) Assignee: PZ Cussons (International) Limited

(21) Appl. No.: 11/247,977

(22) Filed: Oct. 11, 2005

Related U.S. Application Data
(63) Continuation of application No. 10/205,729, filed on Jul. 26, 2002, now abandoned.

(51) Int. Cl. C11D 17/00

(52) U.S. Cl. 510/505; 510/424; 510/499; 510/470

(57) ABSTRACT

A post-foaming cleaning composition for use in an aerosol container which composition comprises a base material comprising at least one detergent, a thickener, and a foam-forming material. The base material has a viscosity greater than 9,500 cps with at least a part of the foam forming material being maintained in suspension in the composition until after the composition is dispensed from the aerosol.

This invention relates to a cleaning composition and more particularly a personal cleaning composition intended for use in a shower.

Although personal cleaning compositions have been developed for showers, such as shower gels, a significantly large number of people prefer to use a conventional bar of soap rather than a shower gel. It is believed that one factor responsible for resistance to the use of shower gels is connected to lather generation. Shower gels are provided in containers or dispensers from which the user must obtain a dose. This finite amount of gel will produce a finite amount of lather. In order to produce the lather the user must apply shear to the gel, for example by rubbing the gel on a part of the body. However, the lather so produced is soon washed away by the stream of water from the shower head. Indeed, in some cases the gel can be washed away and wasted before the user has been able to apply the gel to a part of the body and create a lather. A bar of soap, on the other hand, provides a continuous supply of lather even if the stream of water from the shower head is directed onto the soap bar.

In order to deal with this problem it has been proposed to make provision for the generation of lather from a shower gel as soon as possible after the gel is dispensed. One way of effecting this is to use an aerosol to contain the gel. On release of the contents of the aerosol a foam in the form of a mousse is formed substantially instantaneously. The problem with this proposal is that it is a widely held belief that the generation of a lather by the user of a cleaning composition is essential for satisfactory cleaning. The application of a preformed lather, even if perfectly efficacious is not thought to be so.

WO96/09032A discloses a soap free post-foaming gel composition which is particularly intended for wet shaving using a razor. The composition is preferably prepared by forming a base material consisting of water, a water soluble N-acyl sarcosinate salt and a non-volatile paraffinic hydrocarbon. To this thin, relatively low viscosity mixture is added a volatile hydrocarbon such as isopentane. This addition causes the formation of a gel structure. While this composition is satisfactory for its intended purpose of a shaving foam it does not perform well for personal washing mainly because it gives an uncomfortable “stripped” feeling to the skin. This effect is believed to be caused by the composition removing the natural skin lipids which gives a “squeaky” skin feel which users dislike.

The present invention is intended to provide a post foaming gel composition for personal cleaning which feels good to use.

According to the invention there is provided a cleaning composition for use in an aerosol container, said composition comprising (a) a base material which consists at least of a detergent and a thickener, said base material having a viscosity greater than 9,500 cps and (b) a foam forming material, at least a part of the foam forming material being maintained in suspension in the composition until after the composition is dispensed from the aerosol.

An important feature of the invention is the viscosity of the base material which is such that the base material is already in the form of a gel prior to the inclusion of the propellant. The minimum viscosity of the base material is, as stated, 9,500 cps (measured on a Brookfield viscometer [spindle 4/speed 20]). Preferably, however, the viscosity of the base material is considerably higher, for example above 20,000 cps and more preferably above 30,000 cps and particularly preferably above 60,000 cps (on the same basis of measurement). The base material in the form of a gel is stable and enables a high level of propellant to be included in the composition. The viscosity of the gel composition provides for control of the rate of foaming when the composition is dispensed from the container. In addition the relatively high viscosity of the composition gives stability to the composition during storage prior to use.

It has been found that the foam produced by compositions of the invention have a very different structure to the prior art foams produced from post-foaming compositions. The prior art foam consists of a plurality of small closed cells with a few slightly larger cells here and there. The foam obtained with the invention comprises a plurality of large cells, that is to say up to ten times the size of the largest cells in the prior art foam, with smaller cells filling in the spaces between the larger cells. These smaller cells are in most cases bigger than the largest cells in the prior art foam. The foam of the invention has a high volume and a creamy texture and does not impart the so-called stripping feel to the skin that is experienced with prior art foams.

A preferred embodiment of the invention is intended for use in a shower. In that embodiment a level of propellant is used, for example above 9.0% by weight, which is higher than in prior art foams used for shaving. It has been found that the composition of the invention with such higher levels of propellant are easily rinsed away when used in a shower or other circumstances such as hand washing. Prior art foam, especially foam intended for shaving, with its small cell structure is less readily rinsed away. A shower foam with such a “tight” structure is less readily rinsed away, but instead remains as a foam when washed from the skin and can clog up the waste outlet.

When the composition of the invention is used the formation of a foam or lather is delayed for a short time after the composition is dispensed by virtue of the propellant gas being retained in suspension. Very shortly after dispense agitation of the composition by the user causes the gas to permeate through the composition and a lather or foam is formed. Thus it appears that the user is responsible for creating the lather or foam as with conventional cleaning materials and the composition is seen as providing the behaviour expected for a good cleaning operation.

The thickener used in the composition of the invention must be one that will maintain the propellant gas in suspension until after the composition is dispensed from the aerosol container. Thickeners useful in the present invention include polyacrylic acids, natural and synthetic clays, alginates, collagen thickeners, cellulose thickeners, gelatin, glycerin based thickeners, guar thickeners, polyquaternium thickeners, xantham gum, acrylate copolymers, polyethylene glycol thickeners and glycol esters. The preferred thickeners include-alkanolamides such as coconut diethanolamide, glyceryl esters and derivatives and blends thereof such as glyceryl laurate together with cocamidopropyl betaine and guar gums such as hydroxypropyl trimonium chloride. The amount of thickener used depends upon the particular thickener employed. For example in the case of coconut diethanolamide from 0.05 to 20.0%, preferably from about 2 to 4% and more preferably 3.00 by weight will generally be adequate. With the glyceryl laurate/cocamidopropyl betaine blend amounts of from 0.05 to 30% preferably from 5 to 10% by weight are preferably employed.

The composition of the invention requires sufficient foam forming material so that the composition does not thin and separate. In addition the detergent should also be present in an amount which does not result in the composition thinning. Preferably the amount of detergent should be in the range 0.05 to 60.0% and preferably not less than 7% and more preferably not less than 15% by weight of the total composition.

The particular foam forming material and surfactant system used in the composition is not critical and they can be chosen according to the particular type of composition that is being formulated.

The preferred foam forming materials are saturated aliphatic hydrocarbons having from 4 to 5 carbons such as n-butane, iso-butane, n-pentane and iso-pentane.

Detergents which can be used in this invention include anionic, cationic, nonionic, amphoteric surfactants and mixtures thereof. Detergents which are useful include alkyl polyglucosides, ethoxylated and non-ethoxylated metal alkyl sulphanates, sultanes, taurates, sarcosinates, sulphonates, ether carboxylates, glycinates, quaternary ammonium compounds, polysorbates, sugar esters, alkyl phosphates, propionates, amino acid surfactants, glysides, alkanolamides and betaines.

The particularly preferred detergents used in the invention are anionic surfactants such as alkali metal alkyl ether sulphates, sulphosuccinates and acyl glutamates. A particularly preferred surfactant is sodium lauryl ether sulphate. If desired a mixture of surfactants can be used. These may be all anionic or may be a combination of anionic with one or more of nonionic, amphoteric and cationic surfactants.

The aerosol container may be any such-container that can dispense a post foaming gel.

The invention is further illustrated by the following Examples, reference being also made to the accompanying drawings in which:—

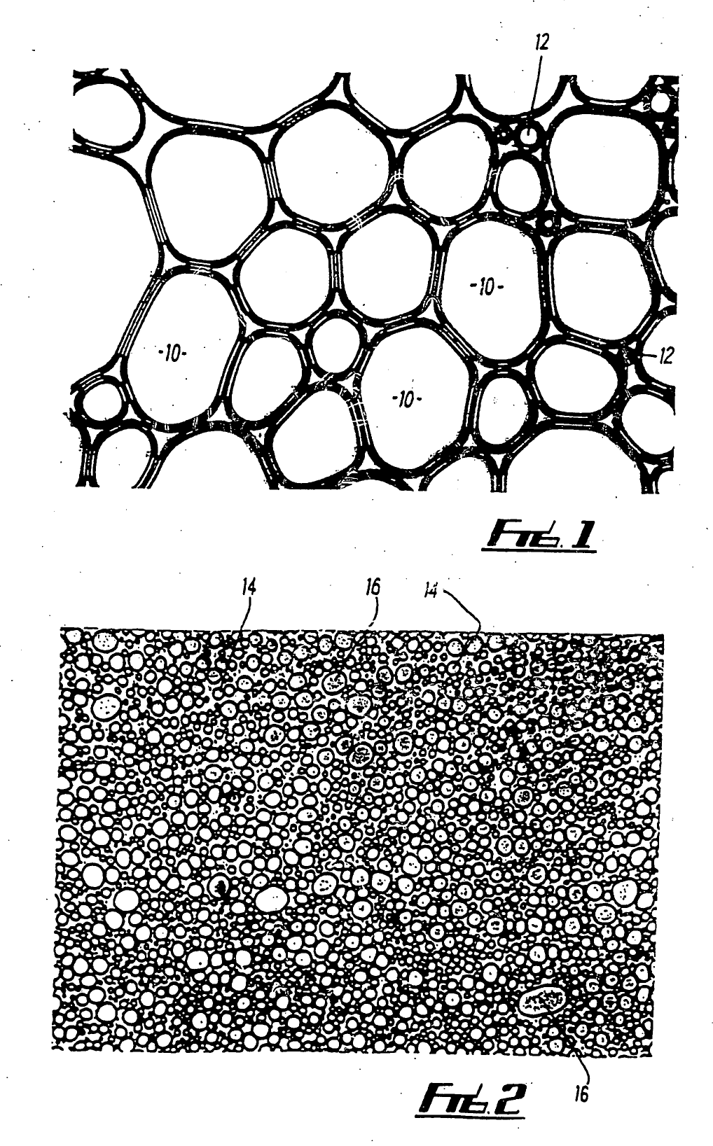

FIG. 1 shows the foam of the invention magnified ten times; and

FIG. 2 shows a prior art sharing foam also magnified ten times.

### EXAMPLE 1

The following base material was prepared (all percentages by weight based on the weight of the final composition):—

| | |
|---|---|
| Cocamidopropyl betaine | 1.5% |
| Cocamidopropyl betaine & glyceryl | 7.0% |
| Laurate Blend | |
| Aminoxide | 0.9% |
| Sodium lauryl ether sulphate | 18.0% |
| Hydroxypropyl Triammonium Guar | 0.3% |
| Fragrance | 0.7% |
| Water (value adjusted to) | 71.6% |

The resultant base material-had a viscosity of 127, 500 cps using a Brookfield viscometer (spindle 4/speed/1). Isopentane was added in the amount of 10% and the resultant composition charged into a bag within an aerosol container.

Butane was used as the propellant gas outside the bag.

The composition was dispensed as a thick shear thinning gel. Foaming started after dispense and the foaming action was increased by agitation of the gel.

The invention is not limited to the above described specific embodiment and many variations and modifications can be made. In particular the invention is not restricted to shower gels and can be applied to other personal cleaning compositions such as hand wash and facial wash compositions and the like.

The foam of the invention was examined under a microscope at ten times magnification and the result is shown in FIG. 1. As can be seen from the Fig. the foam consists of quite large cells 10 of varying shapes with smaller cells 12 filling in spaces between the larger cells. FIG. 2 shows the foam produced from a prior art post foaming gel intended for shaving. That foam consists of much smaller, substantially circular cross section cells 14 with a few somewhat larger cells 16 interspersed at random intervals amongst the smaller cells.

The large cell structure of the foam produced by the composition of the invention is believed to be, at least in part, due to the amount of propellant in the composition. Further when the composition is used in a hot shower, the effect of heat on the composition is to cause the propellant to boil off quickly so that a large amount of foam is produced.

The composition of the invention was submitted to a test panel to assess various attributes or properties thereof. The panel also assessed the same attributes of a conventional bath foam and a conventional tablet of soap. The procedure was as follows:—

A small amount of each product was dispensed onto each panellists hand except for the tablet of soap which was used directly. Each panellist “lathered” (i.e. agitated the product) for 15 seconds followed by rinsing for 15 seconds. They then dried their hands with a towel. They were asked to award a score in respect of various attributes in accordance with the following Table 1.

TABLE 1
1. Ease of Spreading

| V Difficult | | Difficult | | Moderate | | Easy | | V Easy | |
|---|---|---|---|---|---|---|---|---|---|
| 1 | 2 | 3 | 4 | 5 | 6 | 7 | 8 | 9 | 10 |

2. Rate Of Lather Build Up

| V Slow | | Slow | | Moderate | | Fast | | V Fast | |
|---|---|---|---|---|---|---|---|---|---|
| 1 | 2 | 3 | 4 | 5 | 6 | 7 | 8 | 9 | 10 |

3. Amount Of Lather

| V Little | | Little | | Medium | | Much | | V Much | |
|---|---|---|---|---|---|---|---|---|---|
| 1 | 2 | 3 | 4 | 5 | 6 | 7 | 8 | 9 | 10 |

4. Lather Texture

| V Thin | | Thin | | Moderate | | Creamy | | V Creamy | |
|---|---|---|---|---|---|---|---|---|---|
| 1 | 2 | 3 | 4 | 5 | 6 | 7 | 8 | 9 | 10 |

5. Ease of Rinsing

| V Difficult | | Difficult | | Moderate | | Easy | | V Easy | |
|---|---|---|---|---|---|---|---|---|---|
| 1 | 2 | 3 | 4 | 5 | 6 | 7 | 8 | 9 | 10 |

6. Feel of Wet Hands

| | | | | | | | | |
|---|---|---|---|---|---|---|---|---|
| Dislike | Dislike | Dislike | Dislike | Neither like | Like | Like | Like | Like |
| Extremely | V Much | Moderately | Slightly | Nor Dislike | Slightly | Moderately | v much | Extremely |
| 1 | 2 | 3 | 4 | 5 | 6 | 7 | 8 | 9 |

Dry Hands
7. Smoothness

| V Rough | | Rough | | Medium | | Smooth | | V Smooth | |
|---|---|---|---|---|---|---|---|---|---|
| 1 | 2 | 3 | 4 | 5 | 6 | 7 | 8 | 9 | 10 |

8. Softness

| V Harsh | | Harsh | | Medium | | Soft | | V Soft | |
|---|---|---|---|---|---|---|---|---|---|
| 1 | 2 | 3 | 4 | 5 | 6 | 7 | 8 | 9 | 10 |

9. Overall Product Acceptance

| | | | | | | | | |
|---|---|---|---|---|---|---|---|---|
| Dislike | Dislike | Dislike | Dislike | Neither like | Like | Like | Like | Like |
| Extremely | V Much | Moderately | Slightly | Nor Dislike | Slightly | Moderately | v much | Extremely |
| 1 | 2 | 3 | 4 | 5 | 6 | 7 | 8 | 9 |

Skin Feel After 15 mins.
10. Smoothness

| V Rough | | Rough | | Medium | | Smooth | | V Smooth | |
|---|---|---|---|---|---|---|---|---|---|
| 1 | 2 | 3 | 4 | 5 | 6 | 7 | 8 | 9 | 10 |

11. Softness

| V Harsh | | Harsh | | Medium | | Soft | | V Soft | |
|---|---|---|---|---|---|---|---|---|---|
| 1 | 2 | 3 | 4 | 5 | 6 | 7 | 8 | 9 | 10 |

12. Overall Product Acceptance

| | | | | | | | | |
|---|---|---|---|---|---|---|---|---|
| Dislike | Dislike | Dislike | Dislike | Neither like | Like | Like | Like | Like |
| Extremely | V Much | Moderately | Sligthly | Nor Dislike | Slightly | Moderately | v much | Extremely |
| 1 | 2 | 3 | 4 | 5 | 6 | 7 | 8 | 9 |

The results of this evaluation are shown in Table 2.

TABLE 2

| | | | | Sig Level |
|---|---|---|---|---|
| | | | | (Invention |
| | | Tablet | | vs. Best |
| Attribute | Bath Foam | Soap | Invention | Score) |
| Ease of Spreading | 6.2 | 7.05 | 7.85 | <0.1% |
| Rate of Lather Build Up | 5.2 | 6.15 | 9.1 | >0.1% |
| Amount of Lather | 5.05 | 5.7 | 9.1 | >0.1% |
| Lather Texrure | 4.75 | 6.9 | 9.15 | >0.1% |
| Ease of Rinsing | 6.45 | 6.95 | 7.4 | >10% |
| Feel of Wet Hands | 5.4 | 5.45 | 6.65 | >0.1% |
| Smoothness | 6.5 | 6.0 | 7.25 | >1.0% |
| Softness | 6.55 | 5.95 | 7.65 | >0.1% |
| Overall Product | 5.1 | 5.7 | 7.65 | >0.1% |
| Acceptance | | | | |
| Smoothness | 5.95 | 5.8 | 7.35 | >0.1% |
| (after 15 mins) | | | | |
| Softness | 5.8 | 5.6 | 7.3 | >0.1% |
| (after 15 mins) | | | | |
| Overall Product | 5.1 | 5.25 | 7.3 | >0.1% |
| Acceptance | | | | |
| (after 15 mins) | | | | |

The method of production of the composition of the invention using different materials is illustrated in the following Examples 2 to 5. The ingredients used in these Examples are listed in the following Table 3. For convenience the ingredients are referred to by the number in the table.

TABLE 3

| Ingredient | | | |
|---|---|---|---|
| (CTFA Name) | | Trade Name | Supplier |
| 1). | Sodium Lauryl | — | Hickson-Manro |
| | Ether Sulphate | | |
| | SLES (25%) | | |
| 2). | Cocamidopropyl | (Tego Betain L7) | TH Goldschmidt AG. |
| | Betaine | | |
| 3). | Aminoxide | (Aminoxide WS 35) | TH Goldschmidt AG. |
| 4). | Disodium EDTA | — | — |
| 5). | PEG 7 Glyceryl | (Cetiol HE) | Henkel |
| | Cocoate | | |
| 6). | Hydroxypropyl Tri- | (Jaguar C162) | Rhone Poulenc |
| | ammonium Guar | | |
| 7). | Fragrance | — | — |
| 8). | Coconut Diethanol | (Rewomid | Rewo |
| | amide | DC 212/S) | |
| 9). | Sodium Cocoyl | (Elfan AT 84G) | Akzo-Nobel |
| | isethionate | | |
| 10). | Sodium Cocoyl | (Hostapon KCG) | Hoescht |
| | Glutamate | | |
| 11). | Preservative | (Euxyl K400) | Schulke & Mayr |
| 12). | Cocoamidopropyl | (Antil HS 60) | TH Goldschmidt AG. |
| | Betaine & Glyceryl | | |
| | Laurate | | |
| 13). | PEG 4 Rapeseed | (Aminol N) | Chem-Y |
| | Amide | | |
| 14). | PEG 200 Glyceryl | (Rewoderm LI80) | Rewo |
| | Hydrog. Palmiatate | | |
| | (and) PEG 7 | | |
| | Glyceryl Cocoate. | | |
| 15). | Methyl Cellulose | (Benecel MP 943 | Aqualon |
| | | W) | |
| 16). | Water | — | — |

The amounts of the ingredients used in the Examples is set out in the following Table 4.

TABLE 4

| | Example 2 | Example 3 | Example 4 | Example 5 |
|---|---|---|---|---|
| 1). | 71.50% | 54.0% | 71.50% | 71.50% |
| 2). | 5.00% | 5.00% | 5.00% | 5.00% |
| 3). | 1.00% | 1.00% | 1.00% | 1.00% |
| 4). | 0.15% | 0.1% | 0.15% | 0.15% |
| 5). | 1.0% | — | 1.0% | 1.0% |
| 6). | 0.3% | 0.5% | 0.3% | 0.3% |
| 7). | 0.7% | 0.7% | 0.7% | 0.7% |
| 8). | — | 1.0% | — | — |
| 9). | — | 5.0% | — | — |
| 10). | — | 3.36% | — | — |
| 11). | 0.08% | 0.08% | 0.08% | 0.08% |
| 12). | — | 8.00% | — | — |
| 13). | 5.00% | — | — | — |
| 14). | — | — | 5.00% | — |
| 15). | — | — | — | 1.0% |
| 16). | balance | balance | balance | balance |

### EXAMPLE 2

Water was added to (1). The betaine (2) was then added followed by (3). (4) was then dissolved in the mixture. (5)(6) and (7) were mixed together in a premix which was then added to materials (1)-(4). The preservative (11) was then added followed by (13) and the product mixed until a viscosity of 130,000 cps (Brookfield, Spindle RV 4, Speed 0.5) was built.

### EXAMPLE 3

(8) was dissolved in (16) and then added to (1), (2), (3) and (10) were then added along with (4) until dissolved (6), (7) and (8) were premixed and then added to the aforementioned ingredients. (11) was then added followed by (12) and the product mixed until a viscosity of above 100,000 cps (Brookfield, Spindle RV4, Speed 1) was built.

### EXAMPLE 4

Water was added to (1). The betaine (2) was then added followed by (3). (4) was then dissolved in the mixture. (5)(6) and (7) were mixed together in a premix which was then added to materials (1)-(4). The preservative (11) was then added followed by (14) and the product mixed until a viscosity of 60,000 cps (Brookfield, Spindle RV4, Speed 2) was built.

### EXAMPLE 5

Water was added to (1) followed by (15). The betaine (2) was then added followed by (3). (4) was then dissolved in the mixture. (5), (6) and (7) were mixed together in a premix which was then added to materials (1)-(4). The preservative (11) was then added. The viscosity was 26,800 cps (Brookfield, Spindle RV4, Speed 2).

The base materials prepared in the foregoing Examples 2 to 5 were mixed with isopentane (95%) in a 9:1 ratio to produce the post-foaming gel composition of the invention. The composition vas then charged to an aerosol can in the same Way as in Example 1.

1. A cleaning composition for use in an aerosol container, said composition comprising (a) a base material which consists at least of a detergent and a thickener, said base material having a viscosity greater than 9,500 cps and (b) a foam forming material, at least a part of the foam forming material being maintained in suspension in the composition until after the composition is dispensed from the aerosol.

2. A composition as claimed in claim 1, wherein the viscosity is greater than 20,000 and preferably greater than 60,000 cps.

3. A composition as claimed in claim 1, wherein the thickener is selected from one or more of polyacrylic acids, natural clays, synthetic clays, alginates, collagen thickeners, cellulose thickeners, gelatin, glycerin based thickeners and guar thickeners, polyquaternium thickeners, xanthan gum, acrylate copolymers, polyethylene glycol thickeners and glycol esters.

4. A composition as claimed in claim 1, wherein the thickener is an alkanolamide, a glyceryl ester or derivative thereof or a blend thereof with betaine and/or a gum.

5. A composition as claimed in claim 4, wherein the alkanolamide thickener is present in an amount of from 2 to 4% by weight.

6. A composition as claimed in claim 4, wherein the glyceryl blend is present in an amount of from 5 to 10% by weight.

7. A composition as claimed in claim 1, wherein the detergent is present in an amount not less than 7.0% by weight of the total composition.

8. A composition as claimed in claim 1, wherein the detergent is selected from one or more of anionic, cationic, nonionic, amphoteric or mixtures thereof.

9. A composition as claimed in claim 1, wherein the detergent is selected from one or more of alkyl polyglucosides, ethoxylated metal alkyl sulphonates, non-ethoxylated metal alkyl sulfates, sultanes, taurates, sarcosinates, sulphonates, ether carboxylates, glycinates, quaternary ammonium compounds, polysorbates, sugar esters, alkyl phosphates, propionates, amino acid surfactants, glycosides, alkanolamides and betaines.

10. A composition as claimed in claim 1, wherein the foam forming material is a saturated aliphatic hydrocarbon preferably having from 4 to 5 carbons.
